(19) United States
(12) Patent Application Publication
(10) Pub. No.: US 2012/0098869 A1
(43) Pub. Date: Apr. 26, 2012

(54) Light Emitting Diode Circuit, Light Emitting Diode Driving Circuit, and Method for Driving Light Emitting Diode Channels

(75) Inventor: Kuan-Jen TSENG, Sinshih Township (TW)

(73) Assignee: HIMAX ANALOGIC, INC., Sinshih Township (TW)

(21) Appl. No.: 12/910,040

(22) Filed: Oct. 22, 2010

(51) Int. Cl. G09G 5/10

(52) U.S. Cl. 345/690

(57) ABSTRACT

A light emitting diode driving circuit includes a DC-to-DC voltage converter, a pulse width modulator, a shifting circuit, and a plurality of current sink circuits. The DC-to-DC voltage converter generates a driving voltage on first ends of the light emitting diode channels, in which the DC-to-DC voltage converter includes a switch, and a magnitude of the driving voltage is correlated with the conduction time of the switch. The pulse width modulator generates a PWM signal having a duty cycle which drives the switch of the DC-to-DC voltage converter. The plurality of clock cycles on the shifting circuit delays the PWM signal to generate a plurality of phase signals, in which the phase signals have different phases. The current sink circuits are positioned to control the flows of current flowing through the light emitting diode channels according to the phase signals having different phases.

### BACKGROUND

1. Field of Invention

The present invention relates to a LED driving circuit. More particularly, the present invention relates to a LED driving circuit with phase shifting.

2. Description of Related Art

Recently, electronic devices with integrated display panels have become popular. For example, mobile phones, PDAs and MP3 players all have display panels. The display panel needs a light source, such as a backlight module, to enable users to see the text and pictures on the screen. The backlight module usually includes a lot of light emitting diodes (LEDs) that are driven by the light emitting diode driving circuit, in which the LEDs are generally connected together in series in long channels. In such applications, it is desirable that the LEDs provide generally uniform illumination. Accordingly, it is necessary to closely regulate the current applied to the LED channels in order to maintain uniform illumination and provide efficient operation.

However, if there are more and more LED channels connected in parallel, the current generated by the light emitting diode driving circuit becomes greater when the driving circuit is switching between on and off during the dimming tuning, which causes the serious signal noises and the serious voltage/current ripple on the output terminal of the driving circuit.

Accordingly, it is desirable to provide current regulation of LED channels in order to gradually adjust the current on the output terminal of the LED driving circuit, to reduce the amount of the ripple, and to maintain a uniform illumination.

### SUMMARY

According to one embodiment of the present application, a light emitting diode driving circuit for driving a plurality of light emitting diode channels is disclosed. The light emitting diode driving circuit includes a DC-to-DC voltage converter, a pulse width modulator, a shifting circuit, and a plurality of current sink circuits.

The DC-to-DC voltage converter generates a driving voltage on the first ends of the light emitting diode channels, in which the DC-to-DC voltage converter includes a switch. The magnitude of the driving voltage is correlated with the conduction time of the switch. The pulse width modulator generates a PWM signal having a duty cycle which drives the switch of the DC-to-DC voltage converter. A plurality of clock cycles on the shifting circuit delays the PWM signal to generate a plurality of phase signals, in which the phase signals have different phases. The current sink circuits are positioned to control the current flow through the light emitting diode channels according to the phase signals with different phases.

According to another embodiment of the present application, a light emitting diode circuit is disclosed. The light emitting diode circuit includes a plurality of light emitting diode channels, and a light emitting diode driving circuit for driving the light emitting diode channels. The light emitting diode driving circuit includes a DC-to-DC voltage converter, a pulse width modulator, a shifting circuit, and a plurality of current sink circuits.

The DC-to-DC voltage converter generates a driving voltage on first ends of the light emitting diode channels, in which the DC-to-DC voltage converter includes a switch. The magnitude of the driving voltage is correlated with the conduction time of the switch. The pulse width modulator generates a PWM signal having a duty cycle which drives the switch of the DC-to-DC voltage converter. A plurality of clock cycles of the shifting circuit delays the PWM signal to generate a plurality of phase signals, in which the phase signals have different phases. The current sink circuits are positioned to control the flows of current flowing through the light emitting diode channels according to the phase signals having different phases.

According to the other embodiment of the present application, a method for driving a plurality of light emitting diode channels is disclosed. The method generates a PWM signal having a duty cycle, generates a driving voltage on first ends of the light emitting diode channels according to the duty cycle of the PWM signal. The method also employs a plurality of clock cycles that delay the PWM signal to generate a plurality of phase signals, in which the phase signals have different phases, and the method controls the flows of current flowing through the light emitting diode channels according to the phase signals having different phases.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 shows the circuit diagram of the light emitting diode circuit according to one embodiment of the present application;

FIG. 2A shows the circuit diagram of the shifting circuit which includes several phase shifters according to one embodiment of the present invention; and

FIG. 2B shows the waveforms of the PWM signal and the phase signals according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The light emitting diode driving circuit and the light emitting diode circuit of the following embodiments start to turn on the light emitting diode channels at different time intervals which might overlap with each other. As a result, current flowing the light emitting diode channels achieve the maximum volume at different times, such that the total current and the temporal energy from the light emitting diode driving circuit can increase or decrease gradually, and the ripple and the signal noise can be decreased as a result.

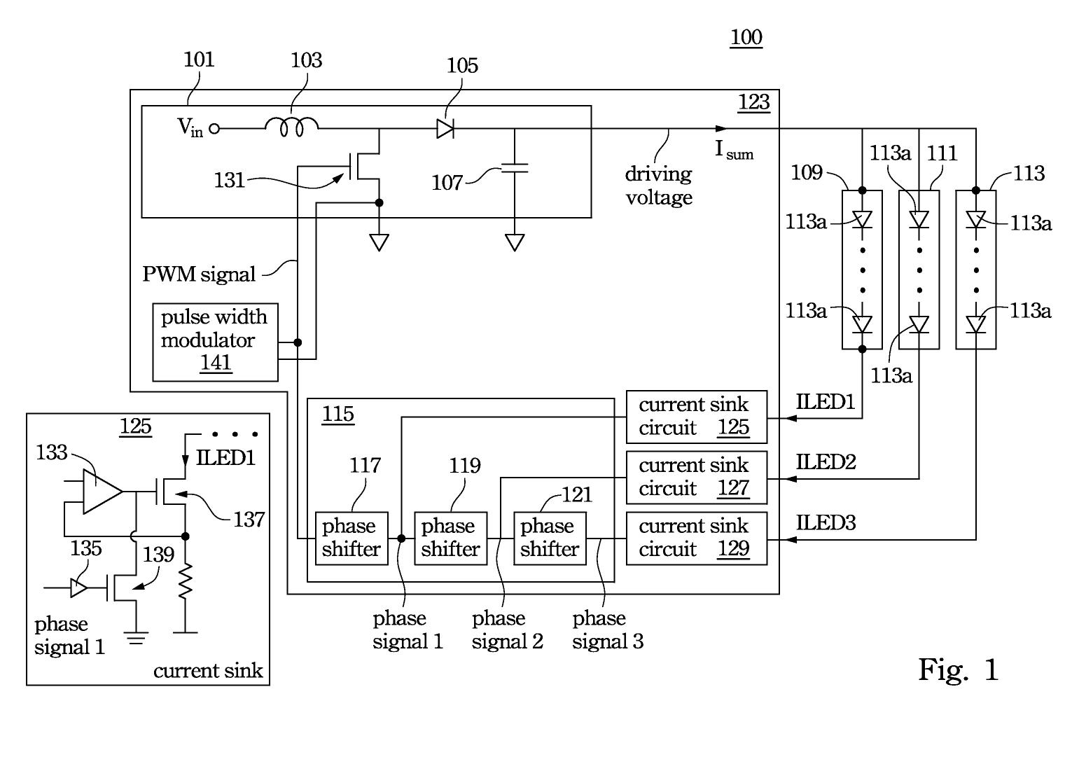

FIG. 1 shows the circuit diagram of the light emitting diode circuit according to one embodiment of the present application, in which the light emitting diode circuit 100 drives several light emitting diode channels 109/111/113. The light emitting diode circuit 100 includes the light emitting diode channel 109, the light emitting diode channel 111, and the light emitting diode channel 113 which have the white light emitting diodes 113a connected in series.

The light emitting diode circuit 100 also includes the light emitting diode driving circuit 123, driving the light emitting diode channel 109/111/113, which includes a DC-to-DC voltage converter 101, a pulse width modulator 141, a shifting circuit 115, and the current sink circuit 125, the current sink circuit 127, and the current sink circuit 129.

The DC-to-DC voltage converter 101 includes the switch 131 generating a driving voltage on first ends of the light emitting diode channel 109/111/113, and the magnitude of the driving voltage is correlated with the conduction time of the switch 131. In other words, the driving voltage corresponds to the conducting period (the conducting time) of the switch 131. For example, if the conducting period or the conducting current of the switch 131 increases, the current stored in the inductor 103 increases as well, which increase the driving voltage.

Except the switch 131, the DC-to-DC voltage converter 101 further includes an inductor 103, a diode 105, and a capacitor 107. The inductor 103 has one end receiving the input voltage Vin and has the other end coupled to a first end of the switch 131, in which the input voltage Vin might be a constant voltage. The diode 105 has an anode coupled to the first end of the switch 131. The capacitor 307 has one end coupled to the cathode of the diode 103 and has the other end receiving the ground voltage.

The pulse width modulator 141 of the light emitting diode driving circuit 123 generates a PWM signal having a duty cycle which drives the switch 131 of the DC-to-DC voltage converter 101. In more detail, the longer the PWM signal's duty cycle lasts, the longer the switch 131 conducts, and the greater the total current Iₛᵤₘ generated on the output terminal of the DC-to-DC voltage converter 101 is.

The shifting circuit 115 delays the PWM signal by several clock cycles to generate the phase signal 1, the phase signal 2, and the phase signal 3, in which the phase signals have the same frequency and different phases, while the phases of those phase signals might overlap each other. This shifting circuit 115 includes the phase shifters 117 receiving the PWM signal and outputting the phase signal 1. The shifting circuit 115 also includes the phase shifter 119 and the phase shifter 121 receiving the phase signal 1 or phase signal 2 from the previous phase shifter 117/119, while the phase shifter 117/119 outputs the phase signal 2 or the phase signal 3 to the next circuit.

The current sink circuit 125/127/129 are positioned to control the flows of current flowing through the light emitting diode channels 109/111/113 according to the phase signals 1, the phase signal 2, and the phase signal 3 which have different phases. The current sink circuit 125 is taken as an example for illustration. The current sink circuit 125 includes the operation amplifier 133, the inverter 135, the transistor 137, and the transistor 139, which are employed to adjust the volume of the current ILED1 flowing through the LED channel 109 according to the phase signal 1.

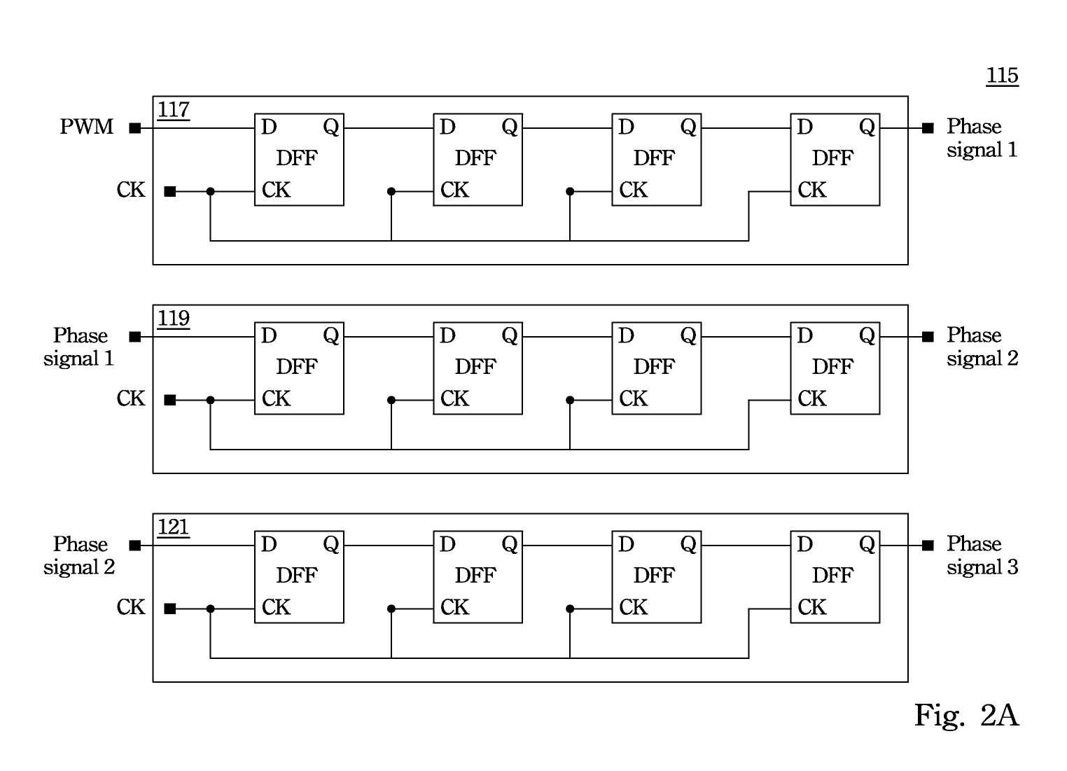

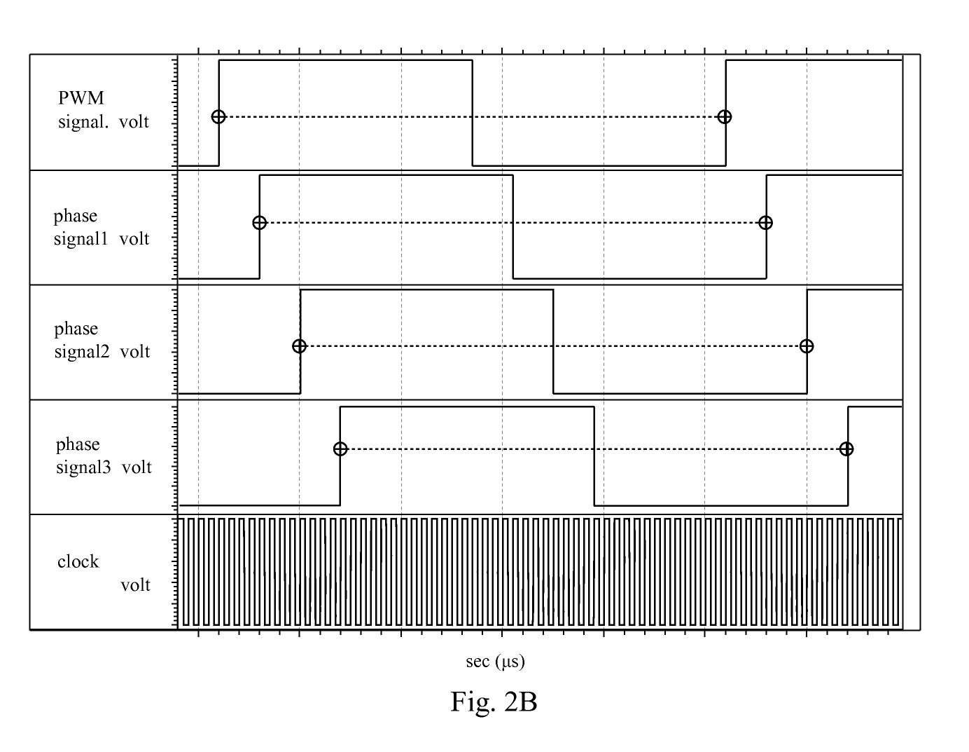

FIG. 2A shows the circuit diagram of the shifting circuit which includes several phase shifters according to one embodiment of the present invention. The shifting circuit 115 includes three phase shifters, that is, the phase shifter 117, the phase shifter 119, and the phase shifter 121, in which each phase shifter includes four D flip flops which are connected in series and receive the same clock signal CK. These phase shifters are connected in series, that is, the phase signal 1 outputting from the phase shifter 117 is inputted to the phase shifter 119, and the phase signal 2 outputting from the phase shifter 119 is inputted to the phase shifter 121.

FIG. 2B shows the waveforms of the PWM signal and the phase signals according to one embodiment of the present invention. The PWM signal, the phase signal 1, the phase signal 2, and the phase signal 3 have the same frequency and different phases, in which the phase signal 1, the phase signal 2, and the phase signal 3 are generated by the phase shifter 117/119/121. In more detail, the rising edge and falling edge of these signals are not aligned but separated by several clock cycle because these signals are delayed from the previous signal by some clock cycles. With phase signals having different phases, the LED channel 109/111/113 are started (turned on) at different times, and the energy as well as the volume of the total current (Iₛᵤₘ in FIG. 1) are not temporally enormous, which reduces the ripple of driving voltage/total current from the LED driving circuit.

According to the above embodiments, the light emitting diode channels are started at different time intervals such that current flows on the light emitting diode channels achieve their maximum volume at different times, such that the total current and the temporal energy from the light emitting diode driving circuit can increase or decrease gradually, and the ripple and the signal noise can be decreased as a result.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light emitting diode driving circuit for driving a plurality of light emitting diode channels, comprising:
a DC-to-DC voltage converter for generating a driving voltage on first ends of the light emitting diode channels, wherein the DC-to-DC voltage converter comprises a switch, and a magnitude of the driving voltage is correlated with conduction time of the switch;
a pulse width modulator for generating a PWM signal having a duty cycle which drives the switch of the DC-to-DC voltage converter;
a shifting circuit with plurality of clock cycles for delaying the PWM signal to generate a plurality of phase signals, wherein the phase signals have different phases; and
a plurality of current sink circuits positioned to control the flows of current flowing through the light emitting diode channels according to the phase signals having different phases.

2. The light emitting diode driving circuit as claimed in claim 1, wherein the phase signals overlap.

3. The light emitting diode driving circuit as claimed in claim 1, wherein the shifting circuit comprises a plurality of phase shifters receiving the PWM signal or the corresponding phase signal from the previous phase shifter and outputting the corresponding phase signal to the next phase shifter.

4. The light emitting diode driving circuit as claimed in claim 3, wherein each of the phase shifters comprises a plurality of D flip flops which are connected in series and receive a same clock signal.

5. The light emitting diode driving circuit as claimed in claim 1, wherein the DC-to-DC voltage converter further comprises:
an inductor having one end receiving an input voltage and the other end coupled to a first end of the switch;
a diode having an anode coupled to the first end of the switch; and
a capacitor having one end coupled to a cathode of the diode and the other end receiving a ground voltage.

6. The light emitting diode driving circuit as claimed in claim 1, wherein the light emitting diode driving circuit is employed to drive the light emitting diode channels composed of white light emitting diodes.

7. A light emitting diode circuit, comprising:
a plurality of light emitting diode channels; and
a light emitting diode driving circuit, comprising:
a DC-to-DC voltage converter for generating a driving voltage on first ends of the light emitting diode channels, wherein the DC-to-DC voltage converter comprises a switch, and a magnitude of the driving voltage is correlated with conduction time of the switch;
a pulse width modulator for generating a PWM signal having a duty cycle which drives the switch of the DC-to-DC voltage converter;
a shifting circuit with a plurality of clock cycles for delaying the PWM signal to generate a plurality of phase signals, wherein the phase signals have different phases; and
a plurality of current sink circuits positioned to control the flows of current flowing through the light emitting diode channels according to the phase signals having different phases.

8. The light emitting diode circuit as claimed in claim 7, wherein the phase signals overlap.

9. The light emitting diode circuit as claimed in claim 7, wherein the shifting circuit comprises a plurality of phase shifters receiving the PWM signal or the corresponding phase signal from the previous phase shifter and outputting the corresponding phase signal to the next phase shifter.

10. The light emitting diode circuit as claimed in claim 9, wherein each of the phase shifters comprises a plurality of D flip flops connected in series and receiving a same clock signal.

11. The light emitting diode circuit as claimed in claim 7, wherein the light emitting diode channel are composed of white light emitting diodes.

12. The light emitting diode circuit as claimed in claim 7, wherein the DC-to-DC voltage converter further comprises:
an inductor having one end receiving an input voltage and the other end coupled to a first end of the switch;
a diode having an anode coupled to the first end of the switch; and
a capacitor having one end coupled to a cathode of the diode and the other end receiving a ground voltage.

13. A method for driving a plurality of light emitting diode channels, comprising:
generating a PWM signal having a duty cycle;
generating a driving voltage on first ends of the light emitting diode channels according to the duty cycle of the PWM signal;
a plurality of clock cycles delaying the PWM signal to generate a plurality of phase signals, wherein the phase signals have different phases; and
controlling the current flowing through the light emitting diode channels according to the phase signals having different phases.

14. The method for driving a plurality of light emitting diode channels as claimed in claim 13, wherein each of the phase signals overlaps part of another phase signal.

15. The method for driving a plurality of light emitting diode channels as claimed in claim 13, wherein the phase signals have the same frequency and different phases.
